(19) United States
(12) Patent Application Publication
(10) Pub. No.: US 2025/0291575 A1
(43) Pub. Date: Sep. 18, 2025

(54) COMMUNICATION DEVICE AND VEHICLE

(71) Applicant: TOYOTA JIDOSHA KABUSHIKI KAISHA, Toyota-shi (JP)

(72) Inventor: Tohru YANAGIDA, Nagoya-shi (JP)

(73) Assignee: TOYOTA JIDOSHA KABUSHIKI KAISHA, Toyotqa-shi (JP)

(21) Appl. No.: 18/976,829

(22) Filed: Dec. 11, 2024

(30) Foreign Application Priority Data
Mar. 14, 2024 (JP) 2024-039828

(51) Int. Cl. G06F 8/65

(52) U.S. Cl. CPC G06F 8/65

(57) ABSTRACT

When the update data of the predetermined software is held in the storage unit, the communication device mounted on the vehicle transmits data information related to the update data to another vehicle existing within a predetermined range in which wireless communication with the vehicle is enabled. The communication device transmits the update data to the other vehicle when receiving a request to transmit the update data from the other vehicle that has received the data information.

### CROSS-REFERENCE TO RELATED APPLICATION

This application claims priority to Japanese Patent Application No. 2024-039828 filed on Mar. 14, 2024, incorporated herein by reference in its entirety.

### BACKGROUND

### 1. Technical Field

The present disclosure relates to updating software that is used in vehicles.

### 2. Description of Related Art

In recent years, there have been developed techniques to update software that is used in vehicles by Over The Air (OTA). For example, Japanese Unexamined Patent Application Publication No. 2022-180976 (JP 2022-180976 A) discloses a technique in which an OTA center requests an OTA master of a vehicle to execute update of particular software when the vehicle is located at a predetermined location. Further, Japanese Unexamined Patent Application Publication No. 2022-028371 (JP 2022-028371 A) discloses a technique in which a control device of a vehicle updates software when the rotational speed of an engine is less than a threshold using update software acquired by OTA.

### SUMMARY

It is an object of the present disclosure to facilitate update of software that is used in vehicles more quickly in a broader range.

A first aspect of the present disclosure provides
a communication device mounted on a vehicle, including
a control unit configured to: transmit data information related to update data for predetermined software that is used in the vehicle to a different vehicle that is present within a predetermined range, in which wireless communication with the vehicle is enabled, when the update data are held in a storage unit; and
transmit the update data to the different vehicle when a request to transmit the update data is received from the different vehicle having received the data information.

A second aspect of the present disclosure provides
a vehicle comprising the communication device according to the first aspect of the present disclosure.

According to the present disclosure, it is possible to facilitate update of software that is used in vehicles more quickly in a broader range.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram for describing exchange of update data according to an embodiment;

FIG. 2 is a block diagram schematically illustrating a configuration of a communication device;

FIG. 3 is a sequence diagram illustrating a flow of processing relating to exchange of update data;

FIG. 4 is a diagram illustrating an example of a table configuration of data information;

FIG. 5 is a flow chart illustrating a portion of a process executed in a communication device of a first vehicle for exchanging updating data between communication devices; and

FIG. 6 is a diagram illustrating an example of a table configuration of travel information.

### DETAILED DESCRIPTION OF EMBODIMENTS

When the software used in the vehicle is updated by OTA, the update data is generally distributed from the external servers to the vehicle to be updated. In this case, in order for the vehicle to receive the update data from the external server, the vehicle needs to exist in an area where communication with the external server is possible. That is, the software cannot be updated in the vehicle outside the area where communication with the external server is possible. Therefore, the present disclosure provides a technique for exchanging update data by vehicle-to-vehicle communication in order to promptly promote updating of software used in a vehicle over a wide range.

A communication device according to the present disclosure is an apparatus on which a vehicle is mounted. The communication device has a function of communicating with various devices outside the vehicle. The communication device includes a storage unit and a control unit. When receiving the update data of the predetermined software used in the vehicle, the communication device stores the received update data in the storage unit. Then, in the vehicle, an update process of updating predetermined software by the update data held in the storage unit of the communication device is executed.

Further, in the communication device, when the update data is held in the storage unit, the control unit executes a process for transmitting the update data to the other vehicle. Specifically, when the update data is held in the storage unit, the control unit transmits the data information to the other vehicle existing within the predetermined range. Here, the data information is information related to the update data. When the other vehicle receives the data information transmitted from the communication device, the other vehicle can determine, based on the data information, whether or not the other vehicle needs to update the predetermined software by the update data. The predetermined range is a range in which wireless communication between the vehicle and another vehicle is possible. That is, the presence of another vehicle within the predetermined range may be that a wireless communication network is established between the vehicle and the other vehicle.

When it is determined that the predetermined software needs to be updated by the update data in the other vehicle that has received the data information from the vehicle, a transmission request for the update data is transmitted from the other vehicle to the vehicle. Therefore, when the vehicle receives a request to transmit the update data from the other vehicle that has received the data information, the control unit transmits the update data to the other vehicle. When the other vehicle receives the update data transmitted from the communication device of the vehicle, the other vehicle can update the predetermined software by the update data.

According to the present disclosure, even if another vehicle that has not received the update data exists outside the area where communication with the external server that distributes the update data is possible, the other vehicle can acquire the update data from the vehicle that already holds the update data. Therefore, according to the present disclosure, it is possible to promptly promote the updating of the software used in the vehicle in a wide range.

Hereinafter, an embodiment of the present disclosure will be described with reference to the drawings. The dimensions, materials, shapes, relative arrangements, and the like of the components described in the present embodiment are not intended to limit the technical scope of the present disclosure only thereto unless otherwise specified.

### Embodiment

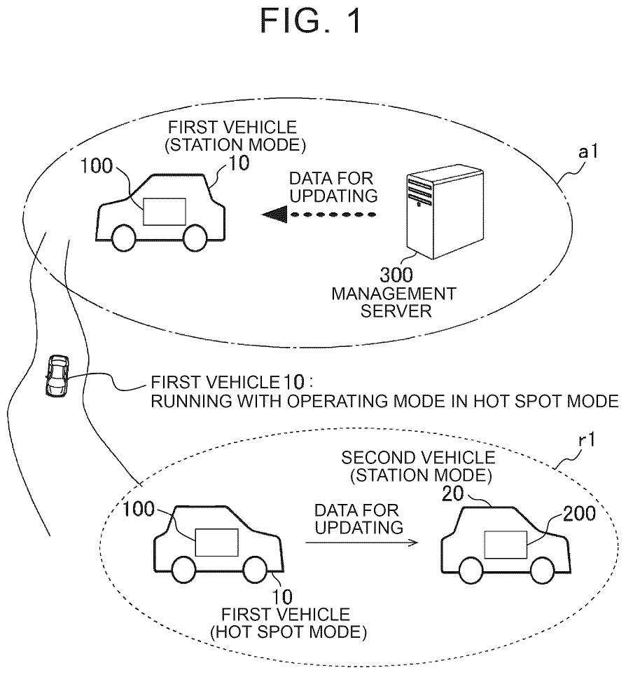

FIG. 1 is a diagram for explaining exchange of update data according to the present embodiment. The update data is data for updating predetermined software used in the vehicle. Note that the predetermined software may be software executed by various ECU, navigational devices, or multimedia devices mounted on vehicles, for example.

In FIG. 1, communication devices 100 and 200 are mounted on the first vehicle 10 and the second vehicle 20, respectively. The communication devices 100 and 200 are devices for each of the vehicles 10 and 20 to perform wireless communication with an external device. The communication devices 100 and 200 have a function of using at least two types of a telephone communication network such as a mobile telephone and a Wi-Fi (registered trademark) communication network as a network for radio communication. The communication devices 100 and 200 can communicate with the management server 300 via the telephone communication network if the vehicles 10 and 20 exist in an area where the telephone communication network can be used. In addition, the communication devices 100 and 200 can communicate with each other via a Wi-Fi communication network if the vehicles 10 and 20 are within a range in which inter-vehicle communication by Wi-Fi can be performed.

Here, the management server 300 is a server that distributes update data. The management server 300 distributes the update data via the telephone communication network. In FIG. 1, the area a1 indicates an area in which communication with the management server 300 can be performed (that is, an area in which a telephone communication network can be used). Therefore, as shown in FIG. 1, when the first vehicle 10 is in the area a1 without holding the data for updating, the communication device 100 receives the data for updating from the management server 300. Upon receiving the update data from the management server 300, the communication device 100 stores the received update data. Then, in the first vehicle 10, a predetermined software update process is executed using the update data.

At this time, in the communication device 100 of the first vehicle 10, the operation mode of Wi-Fi function is the station mode prior to receiving the updating data from the management server 300. When the communication device 100 receives the update data from the management server 300 and stores the update data, the operation mode of Wi-Fi function of the communication device 100 is switched to the hot spot mode. Therefore, when the communication device 100 holds the updating data, the first vehicle 10 travels while the operation mode of Wi-Fi function of the communication device 100 is the hot spot mode.

In addition, the first vehicle 10 may travel outside the area a1. At this time, if the communication device 100 holds the updating data, the operation mode of Wi-Fi function of the communication device 100 is the hot spot mode. Here, as illustrated in FIG. 1, when the first vehicle 10 is traveling outside the area a1, the second vehicle 20 may exist within a predetermined range r1. The predetermined range r1 is a range in which inter-vehicle communication by Wi-Fi can be performed. That is, if the second vehicle 20 exists within the predetermined range r1, a Wi-Fi communication network is established between the communication device 100 of the first vehicle 10 and the communication device 200 of the second vehicle 20. The second vehicle 20 is a vehicle that does not hold update data. Therefore, in the second vehicle 20, the operation mode of Wi-Fi function of the communication device 200 is the station mode, and the second vehicle 20 is traveling.

At this time, since the second vehicle 20 exists outside the area a1 in which communication with the management server 300 is possible, the updating data cannot be received from the management server 300 via the telephone communication network. Therefore, in the present embodiment, when the second vehicle 20 exists within the predetermined range r1, a process for transmitting the updating data from the communication device 100 of the first vehicle 10 to the communication device 200 of the second vehicle 20 via Wi-Fi communication network is executed. When the communication device 200 receives the update data transmitted from the communication device 100 by executing this process, the second vehicle 20 can update predetermined software by the update data.

Although only one second vehicle 20 is illustrated in FIG. 1, when a plurality of second vehicles 20 exist within a predetermined range r1, updating data may be transmitted from the communication device 100 of the first vehicle 10 to the communication devices 200 of the second vehicles 20. In the present embodiment, the communication device 100 functions as a “communication device” according to the present disclosure.

### Configuration of Communication Device

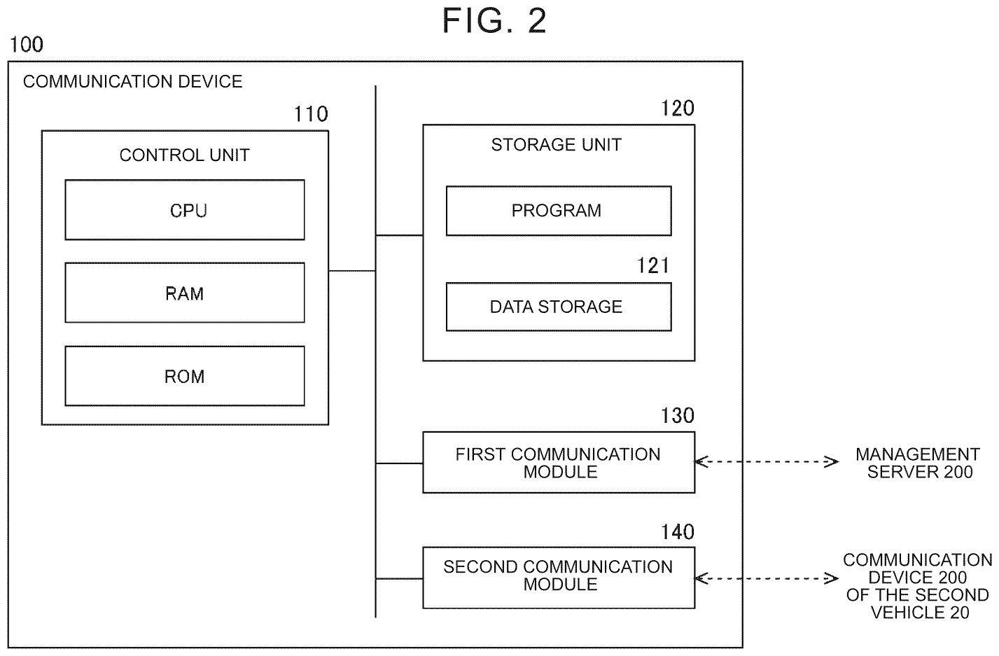

Next, a configuration of the communication device 100 mounted on the first vehicle 10 will be described. FIG. 2 is a block diagram schematically illustrating a configuration of the communication device 100. The communication device 100 includes a control unit 110, a storage unit 120, a first communication module 130, and a second communication module 140. The control unit 110 has a function of performing arithmetic processing for controlling the communication device 100. The control unit 110 includes a processor such as Central Processing Unit (CPU), a main storage device such as Random Access Memory (RAM), and a secondary storage device such as Read Only Memory (ROM). CPU is an exemplary processor resource. RAM and ROM are exemplary memory resources. The control unit 110 can execute arbitrary information processing based on various programs and various data. However, some or all of the functions of the control unit 110 may be realized by a hardware-circuit such as an ASIC, FPGA.

The storage unit 120 is constituted by any storage device such as a RAM, ROM, a hard disk drive, or a flash memory. The storage unit 120 may include a removable medium (portable recording medium). Here, the removable medium is, for example, a USB memory, a SD card, or a disc recording medium such as a CD-ROM, DVD disc or a Blu-ray disc. The storage unit 120 stores programs to be executed by the control unit 110 and various types of data to be used for executing the programs.

The storage unit 120 includes a data storage unit 121 for storing update data. Upon receiving the update data from the outside of the first vehicle 10, the control unit 110 stores the received update data in the data storage unit 121 of the storage unit 120. As a result, the update data is stored in the storage unit 120. Then, in the first vehicle 10, predetermined software is updated using the update data stored in the storage unit 120.

The first communication module 130 is a communication interface for connecting the communication device 100 to a telephone communication network. Therefore, the communication device 100 communicates with the management server 300 using the first communication module 130. The second communication module 140 is a communication interface for connecting the communication device 100 to Wi-Fi communication network. Therefore, the communication device 100 communicates with the communication device of another vehicle (for example, the communication device 200 of the second vehicle 20) using the second communication module 140. The first communication module 130 and the second communication module 140 may be, for example, wireless communication circuits for performing wireless communication according to respective communication standards.

The second communication module 140 has a station mode and a hotspot mode as operation modes of Wi-Fi function. The control unit 110 may switch the operation mode of the second communication module 140 from one of the station mode and the hotspot mode to the other. When the operation mode of the second communication module 140 is the station mode, the communication device 100 functions as a station in Wi-Fi communication network. On the other hand, when the operation mode of the second communication module 140 is the hot spot mode, the communication device 100 functions as a Wi-Fi hot spot in Wi-Fi communication network.

The communication device 200 of the second vehicle 20 has the same configuration as the communication device 100. In the communication device 100 of the first vehicle 10, the operation mode of the second communication module 140 may be a hot spot mode. At this time, when the second vehicle 20 in which the operation mode of the second communication module is the station mode exists in the communication device 200 within the predetermined range r1, a Wi-Fi communication network is established between the communication device 100 and the communication device 200.

In the present embodiment, the communication device 100 is not necessarily realized by a single physical configuration, and may be configured by a plurality of computers provided in the first vehicle 10 and cooperating with each other.

### Exchange of Update Data

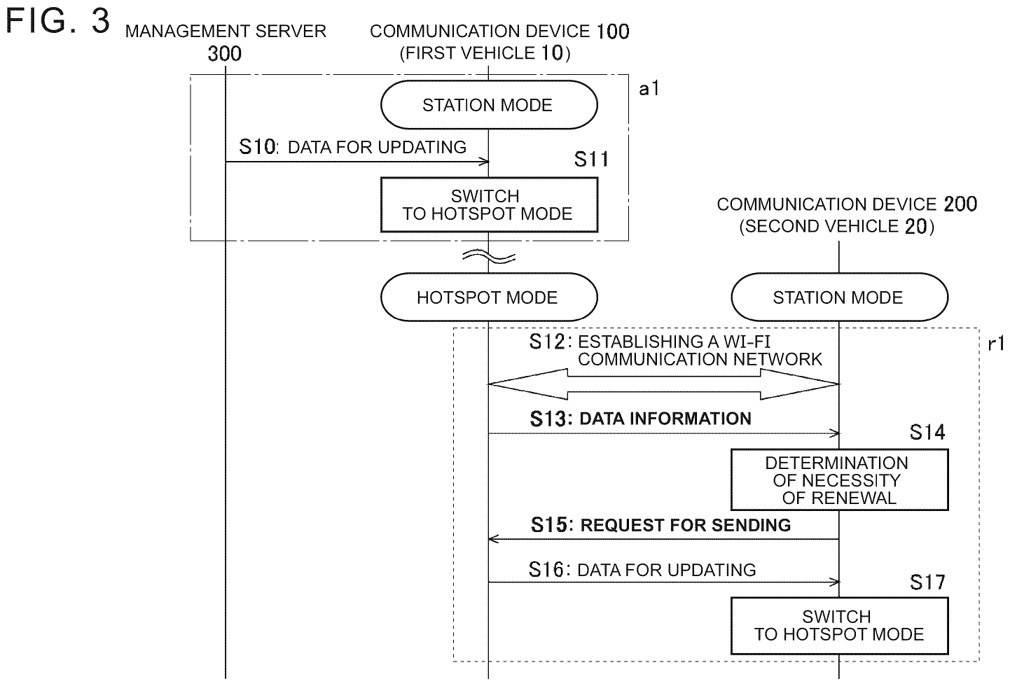

Next, the exchange of update data between the management server 300 and the communication device 100 and between the communication devices 100 and 200 according to the present embodiment will be described with reference to FIG. 3. FIG. 3 is a sequence diagram illustrating a flow of processing related to the exchange of update data.

In the communication device 100 of the first vehicle 10, when the predetermined software update data is not stored in the data storage unit 121, the operation mode of the second communication module 140 is the station mode. Then, when the first vehicle 10 exists in the area a1, the communication device 100 receives the updating data distributed from the management server 300 via the telephone communication network (S10). Then, the control unit 110 executes a process of storing the update data received from the management server 300 in the data storage unit 121 of the storage unit 120. Further, in the first vehicle 10, a process for updating predetermined software using the update data stored in the data storage unit 121 is executed.

Further, in the communication device 100, when the updating data is stored in the data storage unit 121 of the storage unit 120, the control unit 110 switches the operation mode of the second communication module 140 from the station mode to the hotspot mode (S11). Therefore, after this point in time, the first vehicle 10 travels with the operation mode of Wi-Fi function of the communication device 100 in the hot spot mode. Therefore, if the communication device 100 receives the update-use data from the management server 300, the operation mode of Wi-Fi function of the communication device 100 is the hot spot mode even when the first vehicle 10 is traveling outside the area a1.

When the first vehicle 10 is traveling outside the area a1, the second vehicle 20 may exist within a predetermined range r1. At this time, in the second vehicle 20, the operation mode of Wi-Fi function of the communication device 200 is the station mode. In this case, a Wi-Fi communication network is established between the communication device 100 of the first vehicle 10 and the communication device 200 of the second vehicle 20 (S12). The method for establishing a Wi-Fi communication network between the communication device 100 in the hotspot mode and the communication device 200 in the station mode may be any known method.

When a Wi-Fi communication network is established between the communication device 100 and the communication device 200, a process for transmitting updating data from the communication device 100 to the communication device 200 via Wi-Fi communication network is executed. Note that the communication device 100 and the communication device 200 in this process all exchange data/information via Wi-Fi communication network. In addition, in the communication device 100, a process of transmitting or receiving data/information via Wi-Fi communication network is executed by the control unit 110. In addition, the second communication module 140 is used to transmit or receive data or information at this time. This also applies to the communication device 200.

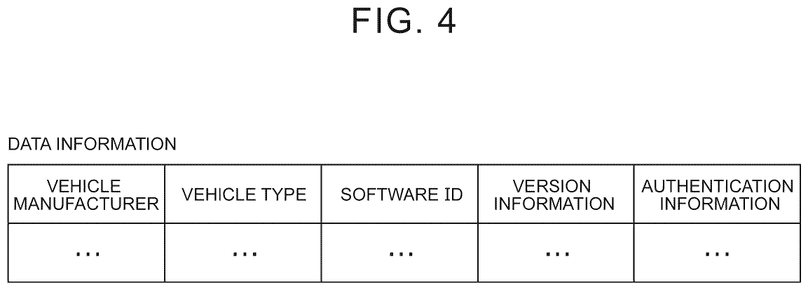

Specifically, first, the communication device 100 transmits data-information to the communication device 200 (S13). Here, the data information is information related to the update data. That is, the data information includes information necessary for determining whether or not the predetermined software needs to be updated by the update data. FIG. 4 is a diagram illustrating an example of a table configuration of data information; As illustrated in FIG. 4, the data information includes a vehicle manufacturer field, a vehicle type field, a software ID field, a version information field, and an authentication information field.

In the vehicle manufacturer field, a manufacturer of a vehicle that uses predetermined software to be updated by the update data is input. In the vehicle type field, a vehicle type of a vehicle using predetermined software is input. In the software ID field, a software ID that is an identification information for identifying a predetermined software is inputted. In the version information field, version information indicating the version of the current update data is input. In the authentication information field, authentication information indicating that the update data is regular data for updating the predetermined software is input. Note that the data information can be generated based on information transmitted from the management server 300 to the communication device 100 together with the update data.

When the communication device 200 receives the data information transmitted from the communication device 100, the communication device 200 performs a process of determining whether or not updating is necessary based on the data information (S14). Here, the process of determining whether or not the update is necessary is a process of determining whether or not the second vehicle 20 needs to update predetermined software based on the update data held by the communication device 100. For example, in the following case, it is determined that updating of predetermined software by the updating data is unnecessary in the second vehicle 20.
When the second vehicle 20 is not the vehicle of the vehicle manufacturer input in the vehicle manufacturer field of the data information
When the second vehicle 20 is not a vehicle of a vehicle type input in the vehicle type field of the data information
In the second vehicles 20, when the predetermined software which the software ID entered in the software ID field shows is not used
When the authentication using the authentication information input in the authentication information field is not satisfied

When the communication device 200 determines that the second vehicle 20 needs to update the predetermined software using the update data held by the communication device 100, it transmits a data transmission request to the communication device 100 (S15). Here, the data transmission request is a signal for requesting transmission of update data to the communication device 200. In a case where the communication device 200 determines that the second vehicle 20 does not need to update the predetermined software by the update data held by the communication device 100, the communication device does not transmit the data transmission request.

When receiving the data transmission request from the communication device 200, the communication device 100 transmits the update-use data to the communication device 200 (S16). In the communication device 200, when the update data is received from the communication device 100 via Wi-Fi communication network, the received update data is stored in the data storage unit of the storage unit. The communication device 200 disconnects Wi-Fi communication network with the communication device 100 after the reception of the updating data from the communication device 100 is completed.

Then, in the second vehicle 20, a process for updating predetermined software using the update data stored in the data storage unit is executed. Further, in the communication device 200, when the data for updating is stored in the data storage unit of the storage unit, the operation mode of the second communication module is switched from the station mode to the hot spot mode (S17). Accordingly, when a Wi-Fi communication network is established between the communication device of the other vehicle in which the operation mode is the station mode and the communication device 200 of the second vehicle 20, the communication device 200 can transmit the updating data to the communication device of the other vehicle.

In some cases, the second vehicles 20 that have not received the update data exist outside the area a1 that can communicate with the management server 300 that distributes the update data via the telephone communication network. According to the present embodiment, even in such a case, the second vehicle 20 can acquire the update data from the first vehicle 10 that already holds the update data. The predetermined software can be updated in the second vehicle 20 by using the update data acquired from the first vehicle 10. Therefore, according to the present embodiment, it is possible to promptly promote the updating of the software used in the vehicle over a wide range. In particular, if the area a1 for which the telephone communication network can be used cannot cover the area in which the second vehicle 20 travels, the present embodiment is advantageous in order to facilitate the updating of the software in the plurality of vehicles.

In the above-described embodiment, a telephone communication network is used to transmit the update data from the management server 300 to the communication devices of the respective vehicles. However, the wireless communication method used for transmitting the update data from the management server 300 to the communication device of each vehicle is not limited to the telephone communication. For example, Wi-Fi or Bluetooth (registered trademark) may be used to transmit updating data from the management server 300 to the communication devices of the respective vehicles. As described above, when a Wi-Fi or a Bluetooth is used for wireless communication between the management server 300 and the communication devices of the vehicles, the area in which communication can be performed is much narrower than when telephone communication is used for wireless communication between them. Therefore, the system according to the present embodiment enables the second vehicle 20 to acquire the update data from the first vehicle 10 that already holds the update data, which is more useful for promoting the update of the software in the plurality of vehicles.

### MODIFIED EXAMPLES

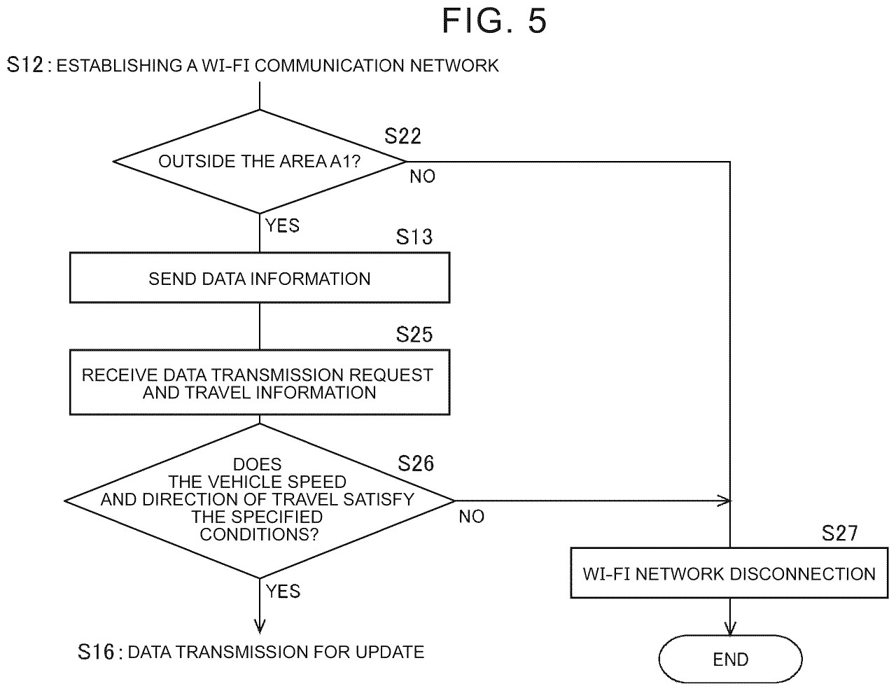

Next, a modification of the present embodiment will be described with reference to FIG. 5. FIG. 5 is a flowchart illustrating a part of processing executed in the communication device 100 of the first vehicle 10 regarding the exchange of update data between the communication devices 100 and 200. In FIG. 5, a portion different from the processing related to the exchange of the update data illustrated in FIG. 3 is mainly illustrated. The flow illustrated in FIG. 5 is executed by the control unit 110 of the communication device 100.

In the present modification, when Wi-Fi communication network is established between the communication device 100 of the first vehicle 10 and the communication device 200 of the second vehicle 20 (S12), S22 process is executed. In S22, it is determined whether or not the first vehicle 10 and the second vehicle 20 exist outside the area a1. At this time, if the communication device 100 can connect to the telephone communication network, a negative determination is made in S22. That is, it is determined that the first vehicle 10 and the second vehicle 20 exist in the area a1. Here, if the second vehicles 20 exist in the area a1, the communication device 200 can directly receive the updating data from the management server 300 via the telephone communication network. Therefore, it is not necessary to exchange update data between the communication device 100 and the communication device 200. Therefore, if a negative determination is made in S22, S27 treatment is executed next. In S27, Wi-Fi communication network with the communication device 200 is disconnected.

On the other hand, when the communication device 100 cannot connect to the telephone communication network, an affirmative determination is made in S22. Here, S13 process is executed. That is, the data information is transmitted to the communication device 200. When the communication device 200 determines that the second vehicle 20 needs to update predetermined software based on the update data held by the communication device 100, the communication device 200 transmits the travel information of the second vehicle 20 to the communication device 100 together with the data transmission request. Therefore, in S25, the communication device 200 transmits the data-transmission request and the travel-information of the second vehicle 20.

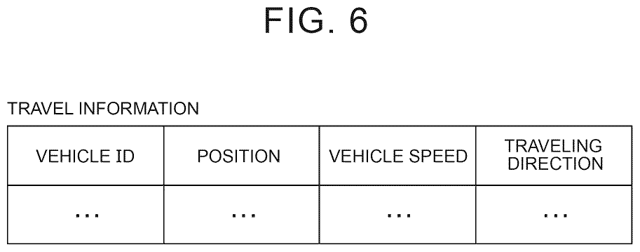

Here, the traveling information of the second vehicle 20 is information related to the traveling of the second vehicle 20. FIG. 6 is a diagram illustrating an example of a table configuration of travel information. As illustrated in FIG. 6, the traveling data includes a vehicle ID field, a position field, a vehicle speed field, and a traveling direction field. In the vehicle ID field, a vehicle ID that is identification information for identifying the second vehicle 20 is inputted. The current position of the second vehicle 20 is input to the position field. The current vehicle speed of the second vehicle 20 is input to the vehicle speed field. In the traveling direction field, the current traveling direction of the second vehicle 20 is input. The travel information may be generated based on information detected by a GPS receiver or various sensors provided in the second vehicles 20.

Here, it takes a certain amount of time for the transmission of the update data from the communication device 100 to the communication device 200 to be completed. Therefore, Wi-Fi communication network between the communication device 100 and the communication device 200 needs to be established for a certain duration. Then, after S25, in S26, it is determined whether or not the vehicle speed and the traveling direction included in the traveling information of the second vehicle 20 satisfy a predetermined condition. The predetermined condition at this time is a condition in which the condition in which the second vehicle 20 exists within the predetermined range r1 is predicted to be continued for a certain period of time.

For example, a Wi-Fi communication network may be established between the communication device 100 and the communication device 200 when both the first vehicle 10 and the second vehicle 20 are at a stop (that is, when the vehicle speed is zero). In such cases, it is expected that a condition in which the second vehicles 20 are within a predetermined range r1 will continue for a certain amount of time. Therefore, the predetermined condition may include that the vehicle speed of the second vehicle 20 is zero. In addition, when both the first vehicle 10 and the second vehicle 20 are traveling in the same traveling direction at a low speed as in a traffic jam, a Wi-Fi communication network may be established between the communication device 100 and the communication device 200. Even in such a case, it is predicted that the condition in which the second vehicles 20 are present within the predetermined range r1 is continued for a certain period of time. Therefore, the predetermined condition may include that the vehicle speed of the second vehicle 20 is equal to or lower than the predetermined speed and that the traveling direction of the second vehicle 20 is the same as the traveling direction of the first vehicle 10.

Therefore, when an affirmative determination is made in S26, it is highly likely that Wi-Fi communication network is established between the communication device 100 and the communication device 200 and is continued for a certain period of time. Therefore, S16 process is executed. That is, the update data is transmitted to the communication device 200. On the other hand, if a negative determination is made in S26, it is highly likely that Wi-Fi communication network established between the communication device 100 and the communication device 200 is not continued. That is, even if transmission of the update data from the communication device 100 to the communication device 200 is started, there is a possibility that Wi-Fi communication network between the two is disconnected during transmission of the update data. Then, S27 process is executed next. That is, Wi-Fi communication network with the communication device 200 is disconnected without transmitting the updating data to the communication device 200.

As described above, according to the present modification, it is possible to suppress Wi-Fi communication network between the communication device 100 and the communication device 200 being disconnected during the transmission of the updating data.

### Other Embodiments

The above-described embodiments are merely examples, and the present disclosure may be appropriately modified and implemented without departing from the scope thereof. For example, the processes and means described in the present disclosure can be free combined and implemented as long as no technical contradiction occurs.

Further, the processes described as being executed by one device may be shared and executed by a plurality of devices. Alternatively, the processes described as being executed by different devices may be executed by one device. In the computer system, it is possible to flexibly change the hardware configuration (server configuration) for realizing each function.

The present disclosure can also be implemented by supplying a computer with a computer program that implements the functions described in the above embodiment, and causing one or more processors of the computer to read and execute the program. Such a computer program may be provided to the computer by a non-transitory computer-readable storage medium connectable to the system bus of the computer, or may be provided to the computer via a network. The non-transitory computer-readable storage medium is, for example, a disc of any type such as a magnetic disc (floppy (registered trademark) disc, hard disk drive (HDD), etc.), an optical disc (compact disc read-only memory (CD-ROM), digital versatile disc (DVD), Blu-ray disc, etc.), a read-only memory (ROM), a random access memory (RAM), an erasable programmable read-only memory (EPROM), an electrically erasable programmable read only memory (EEPROM), a magnetic card, a flash memory, or any type of medium suitable for storing electronic commands such as an optical card.

What is claimed is:

1. A communication device mounted on a vehicle, comprising a control unit configured to:
transmit data information related to update data for predetermined software that is used in the vehicle to a different vehicle that is present within a predetermined range, in which wireless communication with the vehicle is enabled, when the update data are held in a storage unit; and
transmit the update data to the different vehicle when a request to transmit the update data is received from the different vehicle having received the data information.

2. The communication device according to claim 1, wherein:
the control unit is further configured to
cause the communication device to operate in a station mode when the update data are not held in the storage unit, and
switch an operation mode of the communication device from the station mode to a hotspot mode when the update data are received and held in the storage unit; and
the control unit transmits the data information to the different vehicle that is present within the predetermined range when the communication device is operating in the hotspot mode.

3. The communication device according to claim 1, wherein the control unit is configured to:
receive travel information, including a vehicle speed and an advancing direction of the different vehicle, together with the request to transmit the update data, from the different vehicle having received the data information; and
transmit the update data to the different vehicle when the vehicle speed and the advancing direction of the different vehicle included in the travel information meet a predetermined condition.

4. The communication device according to claim 1, wherein the control unit transmits the data information to the different vehicle that is present within the predetermined range when the vehicle and the different vehicle are present outside an area in which it is possible to communicate with an external server that distributes the update data and the update data are held in the storage unit.

5. A vehicle comprising the communication device according to claim 1.
